(19) United States
(12) Patent Application Publication
(10) Pub. No.: US 2014/0257996 A1
(43) Pub. Date: Sep. 11, 2014

(54) Financial Apparatus, Method and System for Receiving and Refunding Fees

(71) Applicant: LG CNS CO., LTD., Seoul (KR)

(72) Inventors: Byoung Youl KIM, Seoul (KR); Hyung Chul KIM, Seoul (KR)

(73) Assignee: LG CNS CO., LTD., Seoul (KR)

(21) Appl. No.: 14/202,700

(22) Filed: Mar. 10, 2014

(30) Foreign Application Priority Data
Mar. 8, 2013 (KR) 10-2013-0025198
Mar. 8, 2013 (KR) 10-2013-0025199

(51) Int. Cl. G06Q 20/10

(52) U.S. Cl. CPC G06Q 20/102
USPC 705/14.67; 705/40

(57) ABSTRACT

A financial apparatus may include: a media reader configured to read user information from a medium; a user interface configured to receive a user's selection for fee receipt; a controller configured to generate a fee receipt request message using the user information and receipt information generated through the fee receipt; a screen display unit configured to display a guide screen for a fee receipt procedure; and a message transmitter/receiver configured to transmit the fee receipt request message to a financial company server, and receive a fee receipt confirmation message corresponding to the fee receipt request message from the financial company server.

### CROSS-REFERENCE TO RELATED APPLICATIONS

This application claims the benefit 35 U.S.C. §119 of Korean Application Nos. 10-2013-0025198, filed on Mar. 8, 2013, and 10-2013-0025199, filed on Mar. 8, 2013, which are incorporated herein by reference in their entirety.

### BACKGROUND

1. Technical Field

Exemplary embodiments of the present invention relate to a financial apparatus and a method and system for receiving and refunding fees.

2. Related Art

In general, customers pay fees through the window of a bank or public office, where other kinds of tasks may be processed, and financial apparatus capable of separately receiving or refunding only fees are not yet provided. Thus, customers may have to wait to pay fees for even tasks which do not need to be performed at the window. As the waiting time increases, the bank or public office may be crowded with customers. Then, the customers may feel uncomfortable. Furthermore, when a customer wants to receive a refund, the customer usually uses a window such that a clerk at the window can check the identity and fee payment of the customer. Therefore, the waiting time inevitably increases to thereby degrade the business efficiency.

Most of automated machines capable of receiving fees are customized for domestic users. Thus, foreign customers have difficulties in using the automated machines. Furthermore, when a foreign customer uses a window of a bank or public office, the foreign customer may have difficulties in receiving a refund because the language spoken by a clerk at the window is limited.

### BRIEF SUMMARY

Various embodiments are directed to a financial apparatus and a method and system for receiving and refunding fees.

In an embodiment of the present disclosure, a financial apparatus may include: a media reader configured to read user information from a medium; a user interface configured to receive a user's selection for fee receipt; a controller configured to generate a fee receipt request message using the user information and receipt information generated through the fee receipt; a screen display unit configured to display a guide screen for a fee receipt procedure; and a message transmitter/receiver configured to transmit the fee receipt request message to a financial company server, and receive a fee receipt confirmation message corresponding to the fee receipt request message from the financial company server.

The medium may include a passport, a fee payment statement, an identification (ID) card, a driver's license, or a receipt, and the media reader may read passport information from the passport, read transaction information from the fee payment statement or the receipt, or read personal information from the ID card or the driver's license.

The controller may identify nationality from the read passport information and sets a guide language, and the screen display unit may display the guide screen in the guide language.

The read passport information may include MRZ (Machine Readable Zone) information, and the MRZ information may include one or more of country, sex, name, passport number, and birth date.

The controller may provide an advertisement or coupon related to the identified nationality.

The fee receipt request message may include one or more of the passport information, fee amount, receipt date, receipt time, transaction type, branch number, machine number, deposit account information, name of recipient, name of deposit bank, and receipt number.

The controller may transmit the passport information received from the media reader to a management server through the financial company server, and perform or terminate the fee receipt procedure when confirmation information of the management server is received through the financial company server.

The financial apparatus may further include a statement generation unit configured to generate a statement when the fee receipt is completed. The controller may receive the fee receipt confirmation message and then control the statement generation unit to generate and output the statement.

The screen display unit may include a menu of passport transaction in initial menus of the financial apparatus, and provide a sub-menu of language selection or fee payment when the passport transaction is selected.

The financial apparatus may further include: a camera configured to take a picture of the user; and a user database configured to store the user picture taken through the camera, the receipt information and the passport information with each other matched.

The controller may generate a refund request message using the user information, when a refund menu is selected through the user interface.

The refund request message may include one or more of passport information, transaction information, fee amount, receipt date, receipt time, transaction type, branch number, machine number, and deposit account information.

The message transmitter/receiver may transmit the refund request message to a financial company server, and receive a refund confirmation message corresponding to the refund request message from the financial company server.

The refund confirmation message may be generated after the financial company server inquires and checks whether refund is possible, through a management server.

In an embodiment of the present disclosure, a method for receiving fees may include: reading user information from a medium; receiving a user's selection for fee receipt; displaying a guide screen for a fee receipt procedure; generating a fee receipt request message using the user information and receipt information generated through the fee receipt, and transmitting the fee receipt request message to a financial company server; and receiving a fee receipt confirmation message corresponding to the fee receipt request message from the financial company server.

In an embodiment of the present disclosure, a method for refunding fees may include: receiving a user's selection for refund of a fee; displaying a guide screen for a fee refund procedure; reading passport information of a passport or transaction information of a statement or receipt through a media reader, or directly receiving the passport information or the transaction information through a user interface; generating a refund request message using the passport information or the transaction information, and transmitting the refund request message to a financial company server; receiving a refund confirmation message corresponding to the refund request message from the financial company server; and providing or transferring a refund amount, when the refund confirmation message is received.

The transaction information may include the transaction number of a statement or the receipt number of a receipt.

The read passport information may include MRZ information, and the MRZ information may include one or more of country, sex, name, passport number, and birth date.

The refund request message may include one or more of the passport information, the transaction information, fee amount, receipt date, receipt time, transaction type, branch number, machine number, and deposit account information.

The refund confirmation message may be generated after the financial company server inquires and checks whether refund is possible, through a management server.

### BRIEF DESCRIPTION OF THE DRAWINGS

Features, aspects, and embodiments are described in conjunction with the attached drawings, in which:

FIG. 1 illustrates a system for receiving fees using a financial apparatus according to an embodiment of the present invention;

FIG. 2 illustrates components of the financial apparatus according to the embodiment of the present invention;

FIG. 3 is a flowchart illustrating a method for receiving fees according to an embodiment of the present invention;

FIG. 4 is a swim lane diagram illustrating the method for receiving fees according to the embodiment of the present invention;

FIG. 5 is a swim lane diagram schematically illustrating a refund procedure of the system for receiving fees according to the embodiment of the present invention;

FIG. 6 is a flowchart illustrating a method for refunding fees according to an embodiment of the present invention; and

FIG. 7 is a swim line diagram illustrating a method for refunding fees according to an embodiment of the present invention.

### DETAILED DESCRIPTION

Hereafter, a financial apparatus and a method and system for receiving and refunding fees according to embodiments of the present invention will be described in detail with reference to the accompanying drawings. When reference numerals are attached to elements of the drawings, like elements have the same reference numerals even though the elements are shown in different drawings. Moreover, detailed descriptions related to well-known functions or configurations will be ruled out in order not to unnecessarily obscure subject matters of the present invention.

When elements according to the embodiments of the present invention are described, terms such as first, second, A, B, (a), and (b) may be used. These terms are only used to distinguish one element from another element, and do not limit the properties or orders of the elements corresponding to the terms. When an element is referred to as being connected or coupled to another element, it should be understood that the former can be directly connected or coupled to the latter, or connected or coupled to the latter via an intervening element therebetween.

Hereafter, the embodiments of the present invention will be described on the supposition that a financial apparatus is used to receive an issuance fee for an alien registration card in an immigration office or the like. However, the supposition is only for convenience of description, and the present invention may be applied to a variety of cases in which expenses required for receiving various private or public services are paid. For example, the present invention may be applied to a case in which fees required for various civil affair documents are paid in a public office such as a community center or city hall and a case in which various taxes such as stamp tax are paid in a court or a driver's license test center. Furthermore, in embodiments for issuing an alien registration card, user information may be read from a passport. However, various user-identifiable media such as a certificate of residence, a driver's license, and a credit cart, which can be carried by a user, may be utilized in addition to the passport. Furthermore, user information may be read from storage media in which a passport copy or the like is stored. The media may include a fee payment statement or receipt as well as a passport, a certificate of residence, and a driver's license.

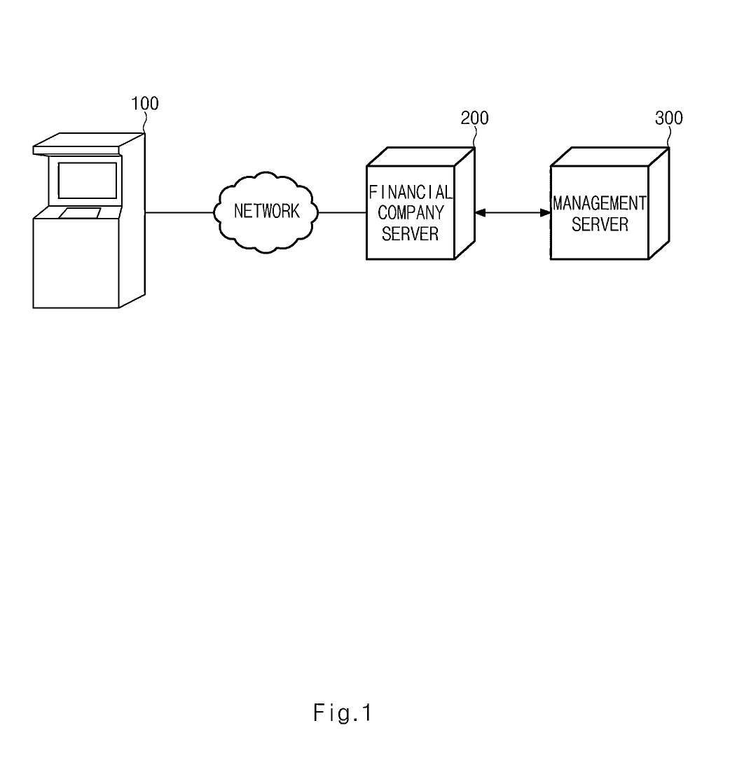

FIG. 1 illustrates a system for receiving fees using a financial apparatus (hereafter, referred to as a fee receiving system) according to an embodiment of the present invention.

The fee receiving system of FIG. 1 may include a financial apparatus 100 installed in an immigration office, a financial company server 200, and a management server 300. FIG. 1 illustrates an example in which the management server 300 is positioned at the rear stage of the financial company server 200. In another embodiment, however, the management server 300 may be installed between the financial apparatus 100 of the immigration office and the financial company server 200. For example, the management server 300 may include a Justice Department server or In-cheon airport server.

According to the embodiment of the present invention, the financial apparatus 100 may be installed in an immigration office which is in charge of issuing an alien registration card. The financial apparatus 100 is an automated machine such as ATM or CD machine, which is capable of handling financial transactions. The financial apparatus 100 may additionally include a function of receiving or refunding an issuance fee for an alien registration card. In this specification, the financial apparatus (for example, ATM) is implemented to include modules required for the function of receiving or refunding an issuance fee for an alien registration card. In another embodiment, however, the function may be implemented as an independent device.

At this time, the financial apparatus 100 operates in connection with the financial company server 200, in order to receive or refund an issuance fee for an alien registration card. Furthermore, the financial apparatus 100 may operate in connection with the management server 300 through the financial company server 200, in order to check the identity of a user.

When the financial apparatus 100 is used to receive a fee, the financial company server 200 may receive a request for fee receipt, and check and confirm receipt information. That is, when receiving a fee receipt request message for the fee paid through the financial apparatus 100, the financial company server 200 checks the fee receipt, and transmits a fee receipt confirmation message corresponding to the fee receipt request message to the financial apparatus 100. Selectively, the financial company server 200 may also receive passport information and use necessary information, or transmit the received passport information to the management server 300, receive an issuance confirmation, and transmit the issuance confirmation to the financial apparatus 100.

Furthermore, when the financial apparatus 100 is used to refund a fee, the financial company server 200 may receive a refund request message, and inquire whether or not the refund is confirmed, through the management server 300. That is, when receiving passport information or statement information from the financial apparatus 100, the financial company server 200 may inquire an internal database of the management server (for example, Justice Department server) using the received passport information or statement information, and receive a confirmation of the refund.

The management server 300 is a server which receives passport information from the financial company server 200, inquires whether the passport information is true or false, whether a fee has been paid twice, whether immigration has been rejected, or whether an owner of the passport is a criminal, based on existing information stored in the management server (for example, information on foreign residents). That is, the management server 300 may check the passport information and transmit the inquiry result on whether the alien registration card issuance was confirmed, whether the fee has been paid twice, or whether immigration has been rejected, to the financial company server 200.

Furthermore, the management server 300 may receive passport information or statement information from the financial company server 200, check the receipt information stored in the internal database thereof (for example, information on whether money was deposited or whether a registration card was issued) on the basis of the received information, and transmit the result to the financial company server 200. That is, the management server 300 may check the passport information or statement information (for example, the receipt number of a receipt), and determine whether the owner of the passport is subject to receive a refund for the alien registration card fee.

Furthermore, the management server 300 may store and manage passport information and receipt information. When the receipt information of a specific person is changed, for example, receipt or refund is completed through the financial apparatus 100, the management server 300 may receive passport information and fee receipt information and update the stored information. That is, the receipt information may be changed according to the information on whether the fee was received or refunded, which is received from the financial apparatus 100 or the financial company server 200. When the receipt information is stored, the receipt information may be matched with the passport information (or statement information). In an embodiment, the financial apparatus 100 may check passport information and receipt information by inquiring the receipt number of a payment receipt or the like through the management server 300, and check the identification information on and receipt information.

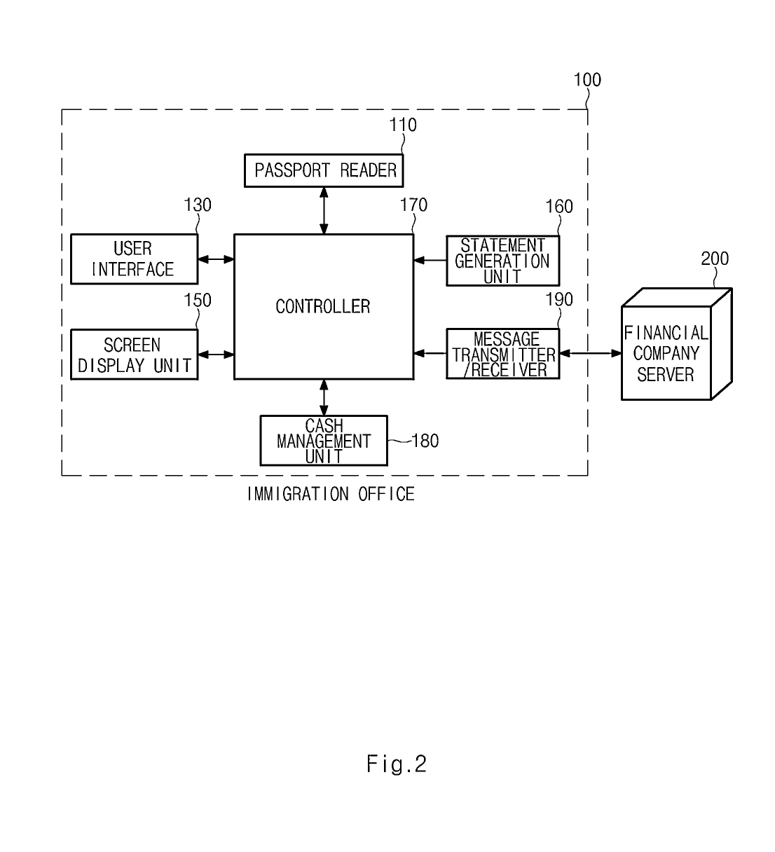

Since tasks which had been processed at the window can be shared and automated through the financial apparatus capable of receiving or refunding fees, it is possible to provide convenience to users and considerably reduce the task processing time. The configuration and operation of the financial apparatus 100 will be described in more detail with reference to FIGS. 2 to 7.

FIG. 2 illustrates components of the financial apparatus 100 according to the embodiment of the present invention.

Referring to FIG. 2, the financial apparatus 100 according to the embodiment of the present invention may include a passport reader 110, a user interface 130, a screen display unit 150, a controller 170, a cash management unit 180, and a message transmitter/receiver 190. The passport reader 110 may read passport information, the user interface 130 may receive a user's selection, the screen display unit 150 may display a guide screen for fee payment or refund to a user, the controller 170 may control the operations of the components, the cash management unit 180 may receive cash and/or check, and the message transmitter/receiver 190 may transmit/receive data to/from the financial company server.

The components included in the financial apparatus 100 are not limited to the above-described components 110, 130, 150, 170, 180, and 190. Furthermore, each of the components may be implemented independently or integrated with another component.

For example, the financial apparatus 100 may include a passport reader 110 for reading passport information from a user's passport, in order to issue an alien registration card as described with reference to FIG. 1.

The passport reader 110 may acquire passport data (for example, image data) by photographing or scanning a passport placed on a predetermined position according to the guide. Then, the passport reader 110 may read passport information from the acquired passport data. The passport information may include machine readable zone (MRZ) information which contains country, sex, name, passport number, and birth date. The passport reader 110 may extract only necessary passport information from the recognized passport data, read all of the passport information, and transmit the read information to the controller 170.

In another embodiment, the financial apparatus having no passport reader 110 may receive passport information such as a passport number through the user interface. For example, the user interface 130 may receive passport information or user information, transmit the received information to the controller 170. Then, the controller 170 may identify the received passport information or user information so as to set a guide language. In another embodiment, the financial apparatus may include a statement recognition module (not illustrated) to read statement information or the receipt number of a receipt. When the financial apparatus does not include such a separate module, the financial apparatus may be implemented to directly receive statement information (for example, the transaction number of a statement or the receipt number of a receipt).

The user interface 130 is a module which receives selections of a guide language and a fee type from a user before and after the passport information is read, or receives a passport number or statement transaction number (receipt number) like the above-described embodiments. In another embodiment, the user interface 130 may be implemented with a separate hardware component such as a button or touch screen capable of performing an interaction. At this time, the user interface 130 may include a software component which receives a selection of a menu provided through the hardware component and transmits the received selection to the controller 170.

For example, when the user interface 130 is implemented with a touch screen, the user interface 130 and the screen display unit 150 may be separated from each other or integrated with each other, because the input and output of the touch screen are performed through the same screen.

In an embodiment, the user interface 130 may receive a selection of guide language at a step where the fee receipt or refund is started. At this time, since a plurality of languages such as English, Japanese, and Chinese can be supported, the limit of window tasks by foreign languages may be overcome, and convenience may be provided.

In another embodiment, country information (or nationality information) of the passport information read through the passport reader 110 may be used to automatically set the guide language. For example, when the nationality information of the passport information indicates that the user is American, the guide language may be set to English, and the screen display unit 150 may display a guide screen in English. Furthermore, the user interface 130 may provide an advertisement or coupon related to the corresponding language. As such, the financial apparatus 100 may acquire the nationality information from the passport information and provide a customized service.

The user interface 130 may receive an amount of fee. For example, a user of the financial apparatus 100 may select a desired amount of fee between 10,000 won corresponding to a typical issuance fee for alien registration card and 14,000 won corresponding to an issuance fee including a delivery service fee.

The message transmitter/receiver 190 may transmit a fee receipt request message or fee refund request message, generated by the controller 170, to the financial company server 200, and receive a confirmation message or refund confirmation message corresponding to the fee receipt request message or fee refund request message. The message transmitter/receiver 190 may transmit the received confirmation message or refund confirmation message to the controller 170.

The controller 170 may perform and control the fee receipt or refund process using the information inputted/outputted through the passport reader 110, the user interface 130, the message transmitter/receiver 190, and the screen display unit 150.

The controller 170 may receive the passport information (for example, MRZ information) or statement information from the passport reader 110, and display a fee amount selection and deposit guide screen through the screen display unit 150 so as to receive a fee.

At this time, the fee may be paid through various methods such as cash, account transfer, credit card, and mobile phone payment. When the fee is paid with cash, the financial apparatus 100 may receive cash through the cash management unit 180. The controller 170 may calculate the change from the received cash, determine whether or not to provide the change, and control the cash management unit 180 to provide the change. When another payment method such as account transfer, credit card, or mobile phone payment is selected, the financial apparatus 100 may perform the fee payment process in connection with the financial company server 120 according to a typical procedure.

The controller 170 may check the amount of fee paid through each method and generate fee receipt information. The fee receipt information may include information on the receipt date, the fee amount, and whether the fee was fully paid. The controller 170 may generate a fee receipt request message using the received passport information and the fee receipt information, and transmit the fee receipt request message to the financial company server 200.

Furthermore, the controller 170 may generate a refund request message using the received passport information or statement information, and transmit the refund request message to the financial company server 200 through the message transmitter/receiver 190.

At this time, the fee receipt request message or fee refund request message may include MRZ information as passport information, fee amount, receipt date, receipt time, transaction type (for example, issuance fee), branch number, machine number (automated machine number), deposit account, name of recipient, name of deposit bank, receipt number and the like. The respective pieces of information may be selectively combined. Then, when a confirmation message for fee receipt is received, the controller 170 may control the statement generation unit 160 to generate and output a statement to a user when the change is given to the user. Furthermore, when a confirmation message for fee refund is received, the controller 170 may control the statement generation unit 160 to generate and output a statement to a user while a refund is returned to the user or transferred to the user's account.

For this operation, the financial apparatus 100 according to the embodiment of the present invention may include the statement generation unit 160. The statement may include receipt information or refund information printed thereon. The receipt information may include information on whether the fee was successfully received, receipt date, name of recipient, fee type, name of deposit bank, receipt number, and fee amount, and the refund information may include information on whether the fee was successfully refunded, refund date, rebater, refund fee type, payment bank, receipt number, and refund amount.

The cash management unit 180 is a device for receiving cash and/or check from a user or providing cash and/or check to a user. The cash management unit 180 may open/close a slot to receive cash or check, recognize and calculate the received cash or check, and return the change according to the control of the controller 170.

In an embodiment, the controller 170 may transmit passport information to the financial company server 200 so as to request a confirmation of whether issuance or refund was approved by the management server 300, after the passport is read or when the message is transmitted. At this time, the financial company server 200 may transmit the received passport information to the management server 300, and receive a confirmation of whether issuance or refund was approved.

That is, the management server 300 may determine whether the owner of the passport information is subject to receive an alien registration card, whether the owner of the passport information paid the fee, or whether an alien registration card was issued, using the existing information stored therein.

For example, the management server 300 may check whether the received passport information is true or false and whether the owner is a criminal or not, and then transmit an alien registration card issuance confirmation. Such an issuance confirmation procedure may be performed at the step where the passport is read in the fee receipt procedure using the financial apparatus 100. Alternately, when a message is transmitted to the financial company server 200, the passport information may be transmitted with the message. When an issuance confirmation is not received, the financial apparatus 100 may display a screen which informs the user that issuance is impossible, and instruct the user to switch to a window task. In an embodiment, the passport information may be encrypted for security of the passport information such that the financial company server 200 cannot inquire the passport information or inquire only a part of the passport information. Furthermore, the financial apparatus 100 may be implemented to receive a fee without requesting or receiving a confirmation of the management server 300 in real time.

Furthermore, the management server 300 may determine whether or not to confirm the refund, using the inquired information, and transmits the information on refund confirmation to the financial company server 200. The financial company server 200 may receive the information on refund confirmation from the management server 300, and transmit the received information to the financial apparatus 100. When a refund confirmation is not received, the financial apparatus 100 may output a screen informing the user that refund is impossible, and terminate the fee refund process. For the security of passport information, the passport information may be encrypted so that the financial company server 200 cannot inquire the passport information or inquire only a part of the passport information. Furthermore, the financial apparatus 100 may be implemented to check the receipt information through the financial company server 200 and refund a fee without requesting or receiving a confirmation of the management server 300 in real time.

Through the above-described components, the financial apparatus 100 according to the embodiment of the present invention may provide the passport read function and the multi-language support function, and perform the fee receipt process in connection with the financial company server 200 and the management server 300. Thus, the financial apparatus 100 may support functions customized to the alien registration card issuance, and share the tasks at the window, thereby maximizing the business efficiency.

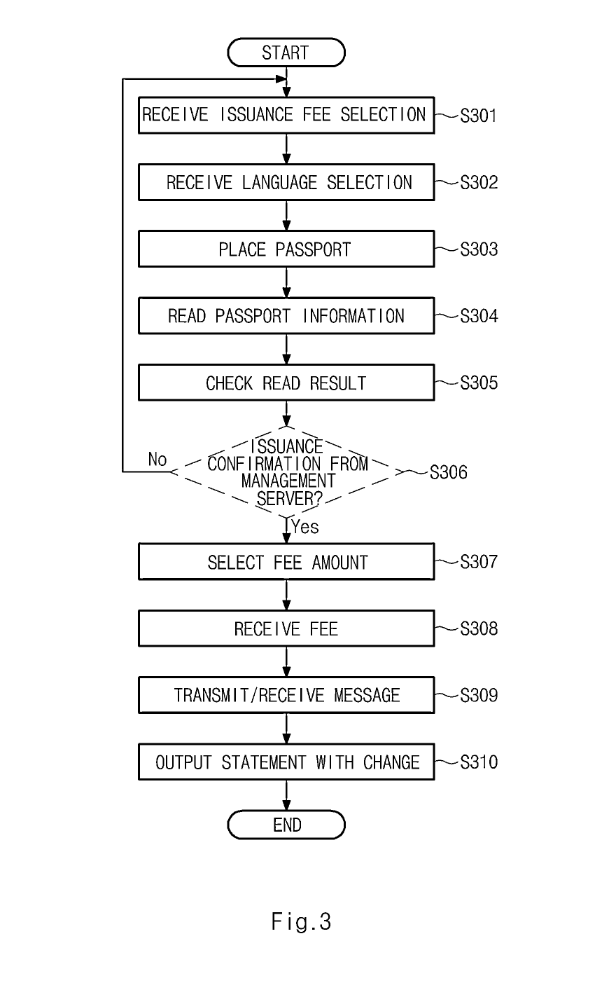

FIG. 3 is a flowchart illustrating a method for receiving fees (hereafter, referred to as a fee receiving method) according to an embodiment of the present invention.

The financial apparatus 100 according to the embodiment of the present invention may support various types of fee payments, and a user may select a fee payment menu to receive an alien registration card. The user interface 130 may receive a selected type of fee at step S301, and transmit the selected type of fee to the controller 170.

In another embodiment, a menu of ‘passport transaction’ (or ‘alien registration card issuance’) may be added to the initial screen of an existing financial apparatus (for example, ATM or CD machine) such that a foreigner easily commits a transaction. For example, a foreign user may select the passport transaction, select a language, and perform a fee payment or refund procedure.

When the type of fee to be received is selected by the input of the user, the user interface 130 receives a selection of language desired by the user such that the user easily performs the fee payment procedure, at step S302. When a specific language (for example, English, Chinese, or Japanese) is selected through the user interface 130, the controller 170 sets the selected language to a guide language such that the subsequent processes are performed in the selected language, and displays a screen in the selected language through the screen display unit 150. Then, the user may see menus displayed in the selected language during the subsequent payment processes. Furthermore, the user may receive an additional service such as advertisement or coupon in the selected language while guide is conducted in the selected language. The multi-language support function is one of the most needed functions in the alien registration card issuance procedure for foreigners, and may not only provide convenience to users, but also improve the efficiency of the payment procedure.

Then, the controller 170 guides the procedure in the selected language and displays a passport position guide screen through the screen display unit 150 in order to induce the user to place the passport at a predetermined position of the financial apparatus 100. The controller 170 may acquire necessary passport information by photographing or scanning the passport through the passport reader 110, at steps S303 and S304. As described above, the passport information may include MRZ information and/or a passport photograph, and the MRZ information may include sex, name, nationality (country), birth date, and passport number. The controller 170 may display the read passport information through the screen display unit 150, request the user to check the passport information, and perform the subsequent payment procedure when the user confirms the passport information, at step S305.

In an embodiment, the financial apparatus 100 according to the embodiment of the present invention may omit the language selection input at step S302. That is, the financial apparatus 100 may read passport information at step S303, set a language, corresponding to country information contained in the passport information, to a guide language and output adaptive menus. In other words, the passport reader 110 may read passport information, and the controller 170 may receive the country information written in the passport from the passport reader 110, and guide the payment procedure in a language corresponding to the country information. Furthermore, the controller 170 may change the language to another language when the user wants to change the language. Moreover, statistics on the nationalities of foreigners using the fee payment service may be collected and used for the development of menu languages, and a customized service for offering an advertisement or coupon related to the corresponding language (or the corresponding country) may be provided.

The financial apparatus 100 may transmit the acquired passport information to the management server 300 through the financial company server 200, and the management server 300 may determine whether or not to confirm the alien registration card issuance by inquiring whether the passport information is true or false and whether the user is a criminal. When the issuance confirmation result corresponding to the passport information transmitted by the financial apparatus 100 is received, the controller 170 may determine whether to perform or terminate the fee payment procedure according to the confirmation result, at step S306. For example, when the issuance is confirmed, the controller 170 may determine to perform the fee payment procedure, and when the issuance is impossible, the controller 170 may terminate the process, induce the user to switch to a window task, or request the user to perform the passport read procedure again. The process of step S306 is not necessarily performed, and may be selectively omitted, if necessary. That is, after the passport information is read, the passport information does not need to be transmitted to the management serve 300 to confirm the issuance, but the user intended to pay the fee may check the passport read result, and then perform the subsequent process.

Then, the financial apparatus 100 may guide the fee payment procedure through the screen display unit 150, and receive a selection of fee amount sat step S307. For example, the user may select a fee amount between 10,000 won corresponding to an issuance fee and 14,000 won corresponding to an issuance fee including a delivery service fee.

The financial apparatus 100 may guide the user to select a fee payment method. The fee payment method may include cash, account transfer, credit card, mobile phone payment and the like. For example, when the user selects cash payment through the user interface 130, the financial apparatus 100 may open the cash management unit 180 to receive cash, and check the amount of cash. When the user selects account transfer, the financial apparatus 100 may execute an account transfer mode (for example, an account transfer process of a general ATM), at step S308. For example, an immigration office may open an account dedicated to fee payment, and use the account as a fee receipt account. That is, the amount of money put into the financial apparatus 100 by the user may be processed in such a manner that the money is deposited into the account dedicated to fee payment, and the amount of money received through the account transfer may be processed in such a manner that the money is transferred to the account dedicated to fee payment from the user's account. The cash payment process or account transfer process is not performed at the current step, but performed while a message is transmitted/received at step S309 to be described below.

When cash is put through the cash management unit 180, the financial apparatus 100 may calculate and check the amount of cash, and display the amount of cash through the screen display unit 150. At this time, when a user's confirmation for the displayed amount is inputted, the controller 170 may receive the amount of cash, and when the user cancels the transaction, the controller 170 may return the cash to the user and then return to the initial stage of the transaction (that is, step S301). The return may be performed at any step of steps S302 to 308, when the user cancels the transaction.

When the fee is received, the controller 170 may generate fee receipt information containing the receipt time, the amount and the like, and generate a fee receipt request message using the fee receipt information and the passport information. At this time, the message may be generated by selectively combining the passport information (for example, MRZ information), the received amount, the date, the time, the transaction type, the branch number, the machine number, the deposit account information and the like. The financial apparatus 100 may transmit the generated message to the financial company server 200, and the financial company server 200 checks the message and receives a confirmation message corresponding to the message, at step S309. When the financial apparatus 100 receives the fee receipt confirmation message, the financial apparatus 100 may output the change and a statement at step S310.

In an embodiment, when the fee payment procedure is completed, the financial apparatus 100 may transmit the process result to the management server 300, and the management server 300 may update the receipt information. That is, the management server 300 may update the information on whether the fee was received, according to the received process result.

In another embodiment, the financial apparatus 100 may further include a camera capable of taking a picture of a user. The financial apparatus 100 may match a picture, taken by the camera during the fee payment procedure, to one or more of the passport information, the fee receipt information, and the messages, and store the matched information in a database thereof or a separate database. The stored information may be inquired through a clear terminal or customer terminal later at the window in the future.

In the above-described fee receiving method, when the passport cannot be read or the fee cannot be received, the controller 170 may guide the user to the window through the screen display unit 150 or call a clerk at the window.

The fee receiving method according to the embodiment of the present invention may provide a fee payment service customized to a user through the user interface 130, and improve the business efficiency by sharing window tasks.

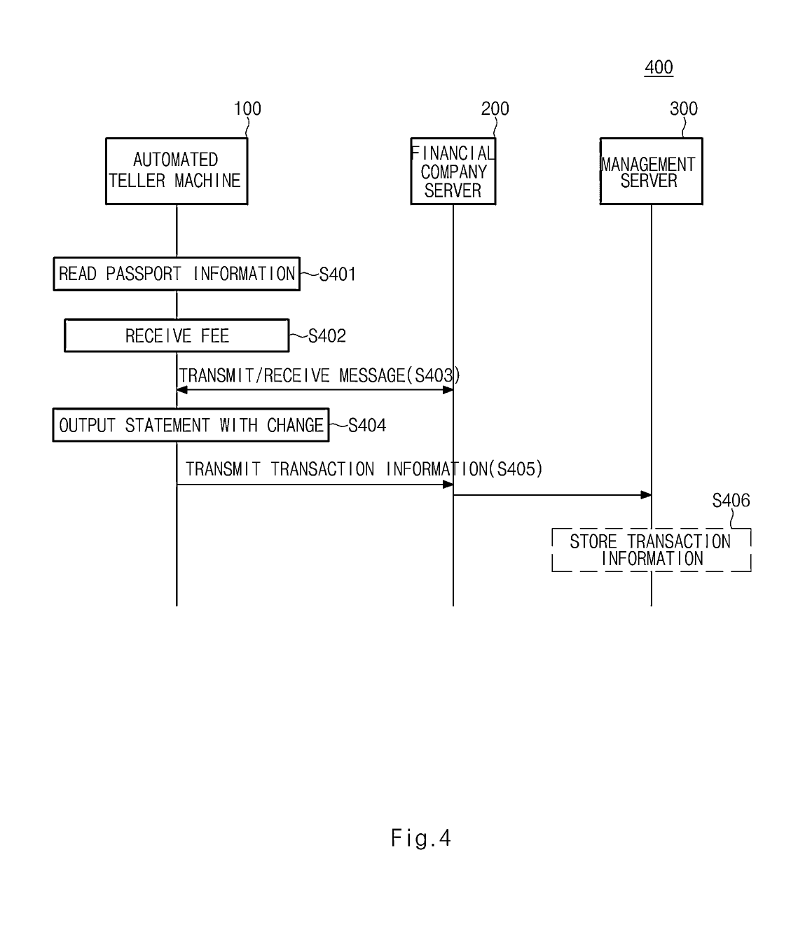

FIG. 4 is a swim lane diagram illustrating the fee receiving method according to the embodiment of the present invention.

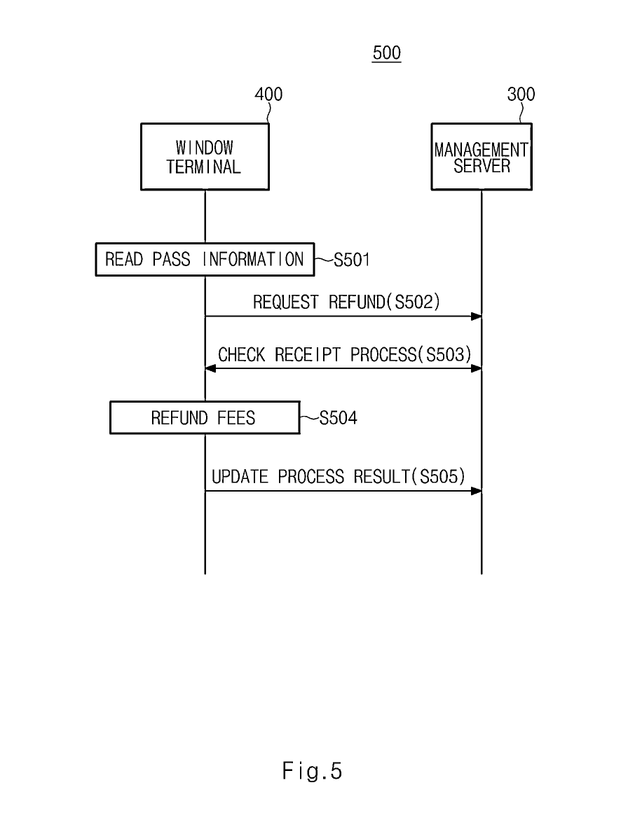

FIG. 5 is a swim lane diagram schematically illustrating a refund procedure 500 of the fee receiving system according to the embodiment of the present invention.

The fee receiving method of FIG. 4 is performed through data transmission/reception between the financial apparatus 100 and the financial company server 200 and the management server 300, as described with reference to FIGS. 1 to 3. The financial apparatus 100 reads passport information through the passport reader 110 at step S401. When the passport is read, the financial apparatus 100 may read nationality information to automatically select a language corresponding to the nationality, and output a fee payment procedure guide in the selected language. Furthermore, the financial apparatus 100 may display a different form of menus or provide a customized advertisement or coupon, depending on the nationality. Moreover, when no card reader is provided, the financial apparatus 100 may directly receive user information through the user interface, and determine the nationality of the user.

In an embodiment, the financial apparatus 100 may read passport information, and then request the management server 300 to check the passport information (not illustrated). The management server 300 may receive the request through the financial company server 200, and check the received passport information. At this time, the management server 300 may determine whether the received passport information contains a reason for disqualification for an alien registration card, based on the existing information stored therein, and transmit the determination result to the financial apparatus 100 through the financial company server 200. The determination result may be transmitted before the fee payment procedure is performed. Alternatively, when the financial apparatus 100 transmits a fee receipt request message, the financial apparatus 100 may transmit the fee receipt request message with the passport information to the management server 300, and request the management server 300 to check the passport information.

Such authentication processes may be selectively omitted, and the financial apparatus 100 may perform the fee payment procedure without a real-time confirmation of the management server 300, as illustrated in FIG. 4.

Then, the financial apparatus 100 may receive the fee according to a confirmation of the management server 300 or without a confirmation of the management server 300, at step S402. As described above, the fee may be paid through various payment methods such as cash and account transfer. When the fee is paid, fee receipt information required for generating a message may be generated. When the generated fee receipt information and the passport information are used to generate a fee receipt request message, the financial apparatus 100 transmits the generated fee receipt request message to the financial company server 200, and then receives a confirmation message from the financial company server 200 at step S403.

The financial apparatus 100 receiving the confirmation message may create a statement and output the created statement with change, at step S404. Selectively, the financial apparatus 100 may store transaction information in a database thereof, match the passport information to receipt information, and then store the matched information in the database. In another embodiment, the financial apparatus 100 may transmit the transaction information to the financial company server 200 at step S405, and transmit the transaction information to the management server 300 such that the receipt information or alien registration card issuance information is stored in the management server (for example, In-cheon airport server) at step S406. That is, when the fee receipt is completed, the financial apparatus 100 may transmit the process result to the management server 300 so as to update the existing transaction information.

FIG. 5 illustrates a refund procedure 500 for refunding an issuance fee for an alien registration card. The refund procedure is performed through a window terminal 400 of an immigration office. That is, the window terminal 400 may include a separate passport reader, a passport may be directly recognized through the passport reader or recognized by a clerk at the window, and passport information (for example, name and passport number) may be read and acquired from the recognized passport, at step S501. In an embodiment, a passport number may be directly inputted through the window terminal 400. In another embodiment, the refund procedure using receipt information may be performed through a process of inputting or scanning a statement or receipt (for example, the receipt number of a receipt).

After the passport information or receipt information is acquired, the window terminal 400 may transmit a refund request to the management server 300, and then access to the management server 300, and check payment information corresponding to the passport information or receipt information (for example, information on whether the fee has been received or/or whether a registration card has been issued) at steps S502 and 503. The window terminal 400 may inquire whether the fee was paid and whether the owner of the passport is subject to receive a refund for the fee, through the management server 300. When the fee is to be refunded, for example, when the fee has been paid but a registration card was not issued, the user may receive a refund with cash or through account transfer. When the refund procedure is completed, the window terminal 400 transmit the process result to the management server 300 such that the management server 300 manage the information on whether the fee was refunded, at step S505.

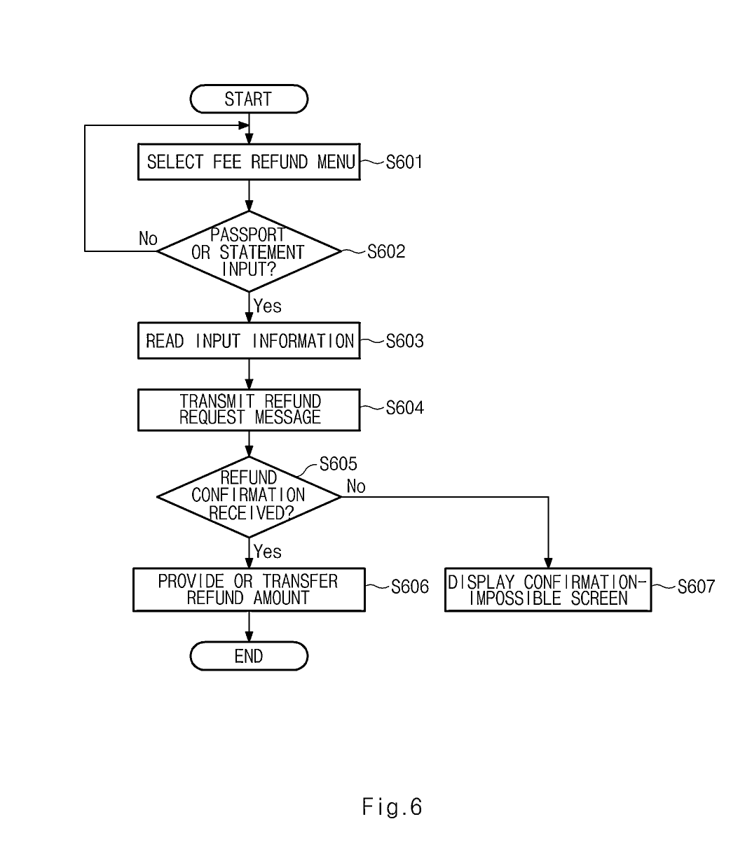

FIG. 6 is a flowchart illustrating a method for refunding fees (hereafter, referred to as a fee refunding method) according to an embodiment of the present invention.

The financial apparatus 100 according to the embodiment of the present invention may support a function of receiving or refunding various types of fees, and a user may select a fee payment menu for alien registration card issuance or a refund menu among the various types of fees, through the user interface 130, at step S601.

The user interface 130 may receive the selected type of fee and transmit the selected type of fee to the controller 170. After the type of fee to be refunded is selected, the user interface 130 may additionally receive a selection of desired language from the user. When a specific language (for example, English, Chinese, or Japanese) is selected, the controller 170 may set the selected language to a guide language such that the refund procedure is guided in the selected language. For example, the screen display unit 150 may display a menu of passport transaction such that a foreigner easily manipulates the financial apparatus 100. When the passport transaction is selected through the user interface 130, the screen display unit 150 may guide the user to select a desired language and a fee payment or refund menu.

Then, the controller 170 may set the language selected by the user to a guide language such that guide is performed in the selected language, and induce the user to place the passport at a predetermined position of the financial apparatus 100, and the passport reader 110 may photograph or scan the passport to acquire necessary passport information at step S602. As described above, the passport information may include MRZ information and/or a passport photograph, and the MRZ information may include sex, name, nationality (country), birth date, and passport number. The passport information may be read through the passport reader and then transmitted to the controller at step S603.

In another embodiment, when the financial apparatus 100 has no passport reader 110, the controller 170 may guide the user to input a passport number through the screen display unit 150, or receive a passport number through the user interface 130 such as a keypad or touch screen. When such a method to receive a passport number is used, the fee refund function according to the embodiment of the present invention may be mounted in existing financial apparatus having no card reader. The utilization of the financial apparatus may be improved.

In another embodiment, the financial apparatus 100 may be implemented to receive a transaction statement or receipt. For example, the financial apparatus 100 may scan or photograph a receipt to read a receipt number, through a receipt reader (not illustrated) corresponding to the passport reader 110, or directly receive a receipt number through the user interface 130. Then, the controller 170 may acquire receipt information (or statement information).

When the input of the passport or statement information is completed, the controller 170 may generate a refund request message and transmit the generated refund request message to the financial company server 200 at step S604. At this time, the refund request message may be generated by selectively combining passport information (for example, MRZ information) or statement information (payment amount, date, time, transaction type, branch number, machine number, deposit account information, or receipt number). The financial company server 200 may receive the refund request message, inquire whether a fee has been paid or a registration card has been issued, through the management server 300, and generate a refund confirmation message (or a message indicating that refund is impossible) according to an inquiry result received from the management server 300. The refund confirmation message generated by the financial company server 200 may be transmitted to the financial apparatus 100, and the financial apparatus 100 receiving the refund confirmation message performs the subsequent refund procedure at step S605.

On the other hand, when the financial apparatus 100 receives the message indicating that refund is impossible, the financial apparatus 100 displays a screen informing the user that refund is impossible, at step S607. Then, the financial apparatus 100 may display a guide screen to guide the user to a window or call a clerk at the window or display a transaction termination screen.

When the refund confirmation message is received from the financial company server 200, the financial apparatus 100 may provide the refund amount with cash or through account transfer at step S606. The refund method may be selected by the user. That is, the financial apparatus 100 may provide cash and/or check to the user through the cash management unit 180 or send cash through account transfer. When the refund procedure is completed, the controller 170 may transmit the process result to the management server 300 to update existing receipt information.

The fee refunding method according to the embodiment of the present invention may provide a fee refund service customized to a user through the user interface 300 which may be easily manipulated by foreigners, reduce the burden of window tasks, and improve the utilization of existing financial apparatus, thereby increasing the business efficiency.

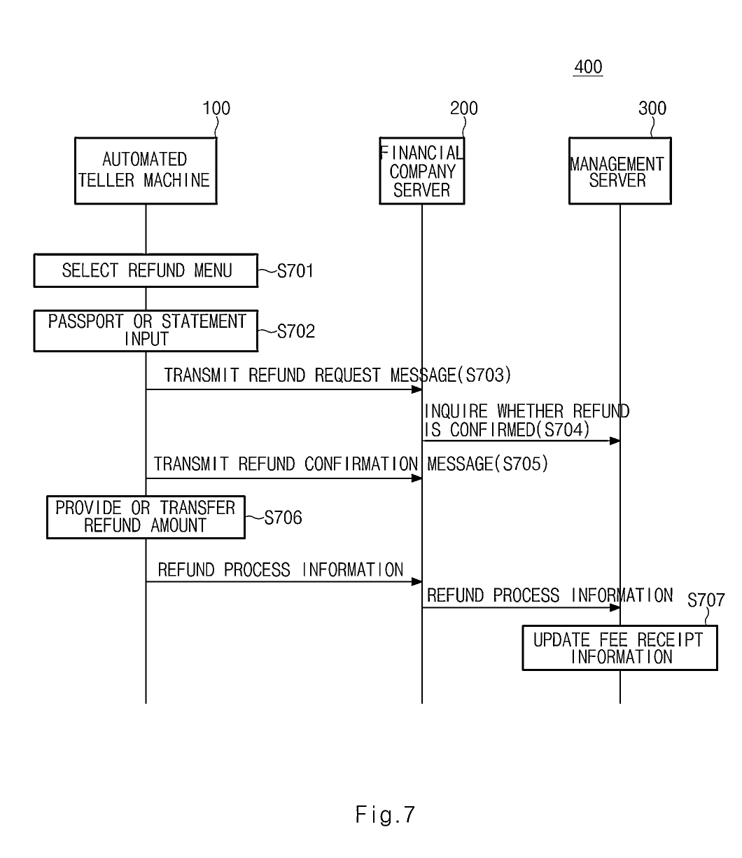

FIG. 7 is a swim line diagram illustrating a refund procedure 400 of a fee refunding system according to an embodiment of the present invention.

The refund procedure of FIG. 7 may be performed through data transmission/reception between the financial apparatus 100 and the financial company server 200 and the management server 300, as described with reference to FIGS. 1, 2, and 6. That is, the refund procedure may be implemented through connection between the financial apparatus 100 and the financial company server 200 and the management server 300. Furthermore, the refund function may be mounted in a general financial apparatus, when the financial apparatus according to the embodiment of the present invention is not installed in an immigration office. For example, when a user selects a menu of passport transaction from the initial menus of an ATM, the refund procedure may performed through language selection and passport recognition (or passport number input).

First, when the user selects a refund menu through the user interface 130 and causes a passport to be recognized through the passport reader 110, the passport reader 110 may read passport information at steps S701 and S702. When the financial apparatus 100 has no passport reader 110, the financial apparatus 100 may be implemented to receive a passport number through the user interface 130. In another embodiment, the financial apparatus 100 may be implemented to receive the transaction number or receipt number of a fee payment receipt or fee payment statement through the user interface 130. In another embodiment, the financial apparatus 100 may acquire image data by photographing or scanning a receipt or statement through a receipt (statement) reader (not illustrated), and the controller 170 may determine statement information (for example, issue date, time, transaction number and the like) or receipt information (for example, date, machine number, and receipt number including serial number) from the acquired image data.

When the passport reader 110 or the receipt reader corresponding to the passport reader 110 reads passport information or receipt or statement information and transmits the read information to the controller 170, the controller 170 of the financial apparatus 100 may generate a refund request message using the information, and transmit the generated refund request message to the financial company server 200 so as to request a refund, at step S703. The refund request message transmitted by the financial apparatus 100 may include MRZ information or a passport number, or include an input or recognized statement transaction number.

The financial company server 200 receiving the refund request may inquire whether the refund is confirmed, through the management server 300, at step S704. In an embodiment, the financial company server 200 may receive MRZ information or a passport number (or statement transaction number) from the financial apparatus 100, generate transaction identification information, and request the management server 300 to inquire whether the refund is confirmed. In another embodiment, the financial company server 200 may transmit the received MRZ information or passport number to the management server 300, and request the management server 300 to inquire whether the refund is confirmed. That is, the financial company server 200 may transmit the received information as it is, or read and process the received information and then transmit the processed information. When a statement transaction number is received, the financial company server 200 may transmit the statement transaction number to the management server 300 and request the management server 300 to inquire whether the refund is confirmed.

The management server 300 may inquire whether a fee for the corresponding passport number was paid, whether a registration card was issued, or whether transaction information exists, based on the information requested from the financial company server 200. When the fee was fully paid, the management server 300 may transmit the check result to the financial company server 200. In the present embodiment, it has been described that the financial company server 200 requests the management server 300 to inquire whether the fee was paid or received, and receives the inquiry result. In another embodiment, however, the financial company server 200 may receive a refund confirmation message as well as the inquiry result through the management server 300.

In the present embodiment, when the inquiry and check procedure is completed through the management server 300, the financial company server 200 may generate a refund confirmation message, and transmit the generated refund confirmation message to the financial apparatus 100 at step S705. The financial apparatus 100 receiving the refund confirmation message from the financial company server 200 may refund the amount with cash or through account transfer according to a user's selection, at step S706.

When the financial apparatus 100 provides cash according to the user's selection, a financial company which acts as a proxy in handling the fee refund task through the financial apparatus 100 may accumulate and manage the amount corresponding to the fees refunded through the financial apparatus 100, demand payment of a company in charge of fee refund in the future, and receive the refund amount. Alternatively, the refund amount may be received from an actual account or virtual account of the company in charge of fee refund, through the financial apparatus 100. Furthermore, when the financial apparatus 100 refunds a fee through account transfer according to a user's selection, the financial company which acts as a proxy in handling the fee refund task may transfer the corresponding amount to an account of a user who requested the fee refund, accumulate and manage the corresponding amount, demand payment of the company in charge of fee refund in the future, and receive the refund amount. Alternatively, the refund amount may be directly transferred to the user's account from the actual account or virtual account of the company in charge of fee refund.

Furthermore, the management server 300 may receive the refund process result from the financial company server 200, and update the existing fee receipt information at step S707. For example, when the management server 300 stores fee receipt information, the management server 300 may store the refund process result by changing ‘paid’ to ‘unpaid’ or ‘refunded’.

Although it has been described that all of the components forming the embodiments of the present invention are combined and operated as one system or method, the present invention is not limited to the embodiments. That is, all of the components may be selectively combined and operated as one or more systems or methods within the scope of the present invention. Furthermore, all of the components may be implemented as one independent hardware component, but a part or all of the components may be selectively combined and implemented as a computer program having a program module to perform a part or all of functions combined in one or more hardware components. Also, functional programs, codes, and code segments forming the computer program can be easily construed by those skilled in the art to which the present invention pertains. The computer program may be stored in computer readable media and read and executed by a computer, thereby accomplishing the embodiments of the present invention. The storage media for the computer program may include magnetic recording media, optical recoding media, carrier wave media and the like.

Furthermore, when it is described that one “comprises” (or “includes” or “has”) some elements, it should be understood that it may comprise (or include or has) only those elements, or it may comprise (or include or have) other elements as well as those elements if there is no specific limitation. The terms including technical or scientific terms have the same meanings as the terms which are generally understood by those skilled in the art to which the present invention pertains, as long as they are differently defined. The terms defined in a generally used dictionary may be analyzed to have meanings which coincide with contextual meanings in the related art. As long as the terms are not clearly defined in this specification, the terms may not be analyzed as ideal or excessively formal meanings.

According to the embodiments of the present invention, since the fee receipt and process may be performed through the financial apparatus, the burden of existing window tasks may be reduced. Furthermore, as the financial apparatus is used, a waiting time for window task may be reduced to thereby increase the efficiency of fee receipt task. Furthermore, since the financial apparatus may identify nationality using input user information or user information read from a medium such as a passport, the guide language may be automatically set.

Moreover, as the financial apparatus supports various languages, the financial apparatus may provide a user interface which is easily manipulated by foreigners, and provide a fee refund service customized to a user.

Furthermore, as existing window tasks for refunding a fee are automated, the burden of the window tasks may be reduced, and an unnecessary waiting time may be reduced. Thus, the waiting time and the process time may be reduced, and the passport information and the receipt information may be efficiently managed. Furthermore, since the present invention may be applied to existing financial apparatus, the cost required for replacing machines may be saved.

While certain embodiments have been described above, it will be understood to those skilled in the art that the embodiments described are by way of example only. Accordingly, the device and method described herein should not be limited based on the described embodiments. Rather, the device and method described herein should only be limited in light of the claims that follow when taken in conjunction with the above description and accompanying drawings.

What is claimed is:

1. A financial apparatus comprising:
a media reader configured to read user information from a medium;
a user interface configured to receive a user's selection for fee receipt;
a controller configured to generate a fee receipt request message using the user information and receipt information generated through the fee receipt;
a screen display unit configured to display a guide screen for a fee receipt procedure; and
a message transmitter/receiver configured to transmit the fee receipt request message to a financial company server, and receive a fee receipt confirmation message corresponding to the fee receipt request message from the financial company server.

2. The financial apparatus of claim 1, wherein the medium comprises a passport, a fee payment statement, an identification (ID) card, a driver's license, or a receipt, and
the media reader reads passport information from the passport, reads transaction information from the fee payment statement or the receipt, or reads personal information from the ID card or the driver's license.

3. The financial apparatus of claim 2, wherein the controller identifies nationality from the read passport information and sets a guide language, and
the screen display unit displays the guide screen in the guide language.

4. The financial apparatus of claim 2, wherein the passport information comprises MRZ (Machine Readable Zone) information, and
the MRZ information comprises one or more of country, sex, name, passport number, and birth date.

5. The financial apparatus of claim 4, wherein the controller provides an advertisement or coupon related to the identified nationality.

6. The financial apparatus of claim 2, wherein the fee receipt request message comprises one or more of the passport information, fee amount, receipt date, receipt time, transaction type, branch number, machine number, deposit account information, name of recipient, name of deposit bank, and receipt number.

7. The financial apparatus of claim 2, wherein the controller transmits the passport information received from the media reader to a management server through the financial company server, and performs or terminates the fee receipt procedure when confirmation information of the management server is received through the financial company server.

8. The financial apparatus of claim 1, further comprising a statement generation unit configured to generate a statement when the fee receipt is completed,
wherein the controller receives the fee receipt confirmation message and then controls the statement generation unit to generate and output the statement.

9. The financial apparatus of claim 1, wherein the screen display unit comprises a menu of passport transaction in initial menus of the financial apparatus, and provides a sub-menu of language selection or fee payment when the passport transaction is selected.

10. The financial apparatus of claim 2, further comprising:
a camera configured to take a picture of the user; and
a user database configured to store the user picture taken through the camera, the receipt information and the passport information with each other matched.

11. The financial apparatus of claim 1, wherein the controller generates a refund request message using the user information, when a refund menu is selected through the user interface.

12. The financial apparatus of claim 11, wherein the refund request message comprises one or more of passport information, transaction information, fee amount, receipt date, receipt time, transaction type, branch number, machine number, and deposit account information.

13. The financial apparatus of claim 11, wherein the message transmitter/receiver transmits the refund request message to a financial company server, and receives a refund confirmation message corresponding to the refund request message from the financial company server.

14. The financial apparatus of claim 13, wherein the refund confirmation message is generated after the financial company server inquires and checks whether refund is possible, through a management server.

15. A method for receiving fees, comprising:
reading user information from a medium;
receiving a user's selection for fee receipt;
displaying a guide screen for a fee receipt procedure;
generating a fee receipt request message using the user information and receipt information generated through the fee receipt, and transmitting the fee receipt request message to a financial company server; and
receiving a fee receipt confirmation message corresponding to the fee receipt request message from the financial company server.

16. A method for refunding fees, comprising:
receiving a user's selection for refund of a fee;
displaying a guide screen for a fee refund procedure;
reading user information from a medium through a media reader, or directly receiving the user information through a user interface;
generating a refund request message using the user information, and transmitting the refund request message to a financial company server;
receiving a refund confirmation message corresponding to the refund request message from the financial company server; and
providing or transferring a refund amount, when the refund confirmation message is received.

17. The method of claim 16, wherein the user information comprises a transaction information of a statement or a receipt, and the transaction information comprises a transaction number of a statement or the receipt number of a receipt.

18. The method of claim 16, wherein the user information comprises a passport information, and
the read passport information comprises MRZ information, and
the MRZ information comprises one or more of country, sex, name, passport number, and birth date.

19. The method of claim 16, wherein the refund request message comprises one or more of the user information, fee amount, receipt date, receipt time, transaction type, branch number, machine number, and deposit account information.

20. The method of claim 16, wherein the refund confirmation message is generated after the financial company server inquires and checks whether refund is possible, through a management server.
